(19) United States
(12) Patent Application Publication
(10) Pub. No.: US 2011/0226799 A1
(43) Pub. Date: Sep. 22, 2011

(54) ADJUSTABLE CUP DISPENSER

(75) Inventors: Jeffrey Craig Watson, Franklin, TN (US); Steven Alan Haug, Nolensville, TN (US); Guo De Huang, FoShan (CN)

(73) Assignee: NIRO-PLAN AG, Aaburg (CH)

(21) Appl. No.: 13/125,699

(22) PCT Filed: Oct. 26, 2009
(86) PCT No.: PCT/EP2009/007636

§ 371 Date: Apr. 22, 2011

Related U.S. Application Data
(60) Provisional application No. 61/108,218, filed on Oct. 24, 2008.

(51) Int. Cl. B65G 59/00; B65D 83/00; F16B 2/20

(52) U.S. Cl. 221/199; 221/279

(57) ABSTRACT

An assembly for holding cup-shaped objects. The assembly includes an outer retaining tube, an inner retaining tube having a diameter smaller than that of the outer retaining tube, wherein the inner retaining tube engages the outer retaining tube in a telescoping manner, a spring positioned inside the tubes, a piston positioned at a first end of the spring, and a head assembly that engages the outer retaining tube, the head assembly containing a ring assembly operably connected to a plurality of flippers that, in response to rotation of the ring assembly, provide a varying diameter within the head assembly. The telescoping feature provides for adjustable length of the assembly while the varying diameter of the head assembly provides for cups of various diameters to be used in the assembly.

The present document relates to a dispenser for one-at-a-time dispensing of objects such as beverage cups or other cup-shaped objects, and more specifically, relates to a dispenser for one-at-a-time dispensing of objects such as beverage cups having various sizes and opening diameters.

Cup and similar cup-shaped object dispensers are used in many restaurant and retail environments. Cup dispensers provide a convenient and sterile device for storing a large amount of cups in a relatively small space. Typical cup dispensers often hold cups within a tube or cylinder in a nested or stacked relationship. Cups are dispensed one at a time from an open end of the tube. Similarly, the cup dispensers are loaded by pushing one or more cups into the dispenser through the same open end. The open end may have a rubber or plastic gasket or similar flexible device to hold the cups in the dispenser while allowing one or more cups to be removed from the open end with an application of a pulling force. Depending on the location and orientation of the cup dispenser, gravity or a pressure based pushing mechanism will push or draw the cups toward the open end.

Current cup dispensers typically have several drawbacks. Cup dispensers have a fixed size open end and thus are not easily customizable for cups having different opening diameters. In addition, many tubes of current cup dispensers are a single, solid piece of molded plastic or rolled metal of a fixed length, and cannot take maximum opportunity of the available space of various types of cabinets in which they are placed.

The invention described in this document is not limited to the particular systems, methodologies or protocols described, as these may vary. The terminology used herein is for the purpose of describing particular embodiments only, and is not intended to limit the scope of the present disclosure.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In one general respect, the embodiments disclose an assembly for holding cup-shaped objects. The assembly includes an outer retaining tube, an inner retaining tube having a diameter smaller than that of the outer retaining tube, wherein the inner retaining tube engages the outer retaining tube in a telescoping manner, a spring positioned inside the tubes, and a piston positioned at a first end of the spring.

In another general respect, the embodiments disclose an assembly for holding cup-shaped objects. The assembly includes an outer retaining tube, an inner retaining tube having a diameter smaller than that of the outer retaining tube, wherein the inner retaining tube engages the outer retaining tube in a telescoping manner, a spring positioned inside the tubes, a piston positioned at a first end of the spring, and a head assembly that engages the outer retaining tube, the head assembly containing a ring assembly that when rotated provides a varying diameter within the head assembly.

In another general respect, the embodiments disclose an assembly for holding cup-shaped objects. The assembly includes an outer retaining tube, an inner retaining tube having a diameter smaller than that of the outer retaining tube, wherein the inner retaining tube engages the outer retaining tube in a telescoping manner, a spring positioned inside the tubes, a piston positioned at a first end of the spring, and a head assembly that engages the outer retaining tube, the head assembly containing a ring assembly operably connected to a plurality of flippers that, in response to rotation of the ring assembly, provide a varying diameter within the head assembly.

Aspects, features, benefits and advantages of the present invention will be apparent with regard to the following description and accompanying drawings, of which:

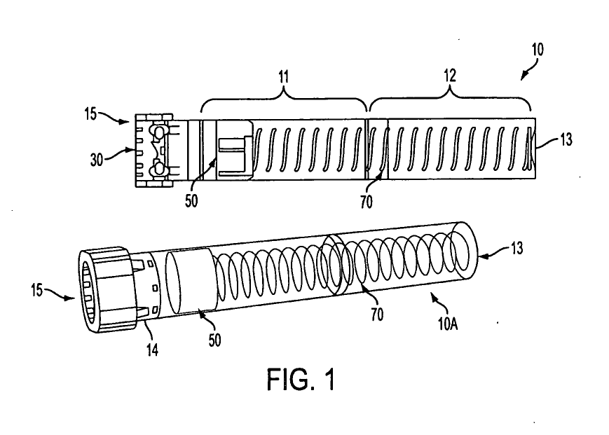

FIG. 1 illustrates an exemplary embodiment of an adjustable cup dispenser;

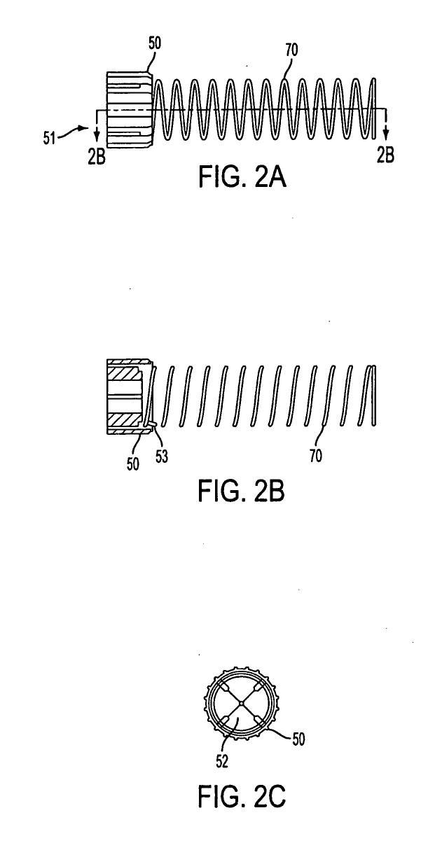

FIG. 2 illustrates an exemplary spring and piston assembly;

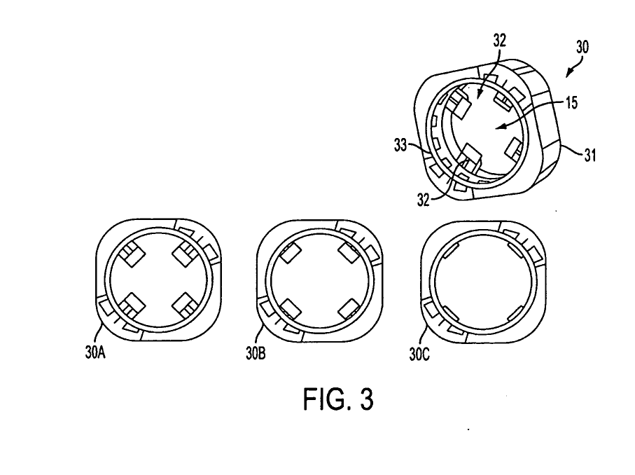

FIG. 3 illustrates an exemplary head structure;

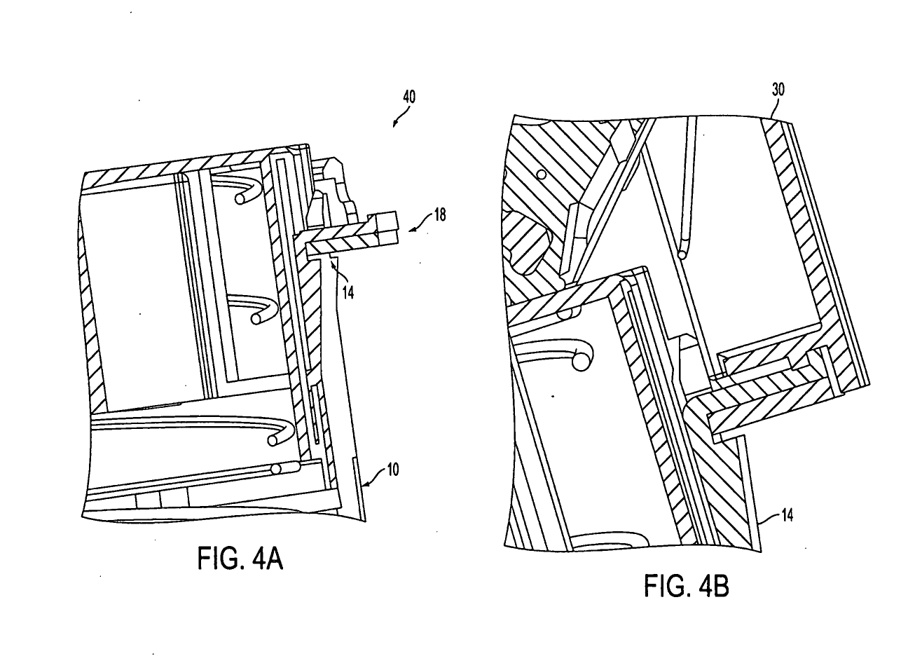

FIGS. 4A and 4B illustrate internal features of the exemplary head structure of FIG. 3;

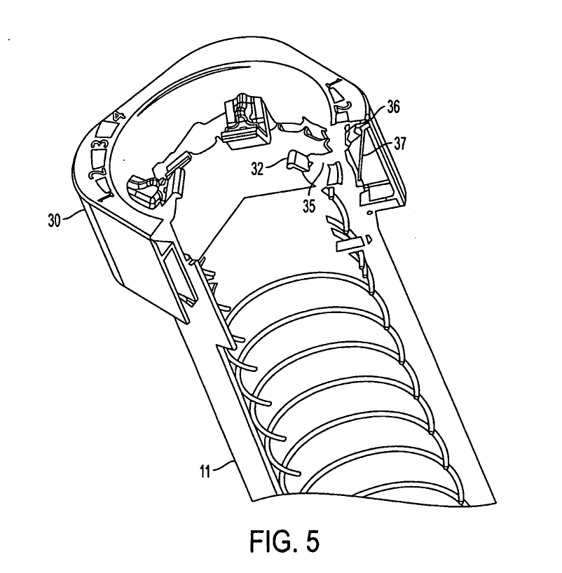

FIG. 5 illustrates an alternate cut-away view of the head structure of FIG. 3 with the dispenser of FIG. 1; and

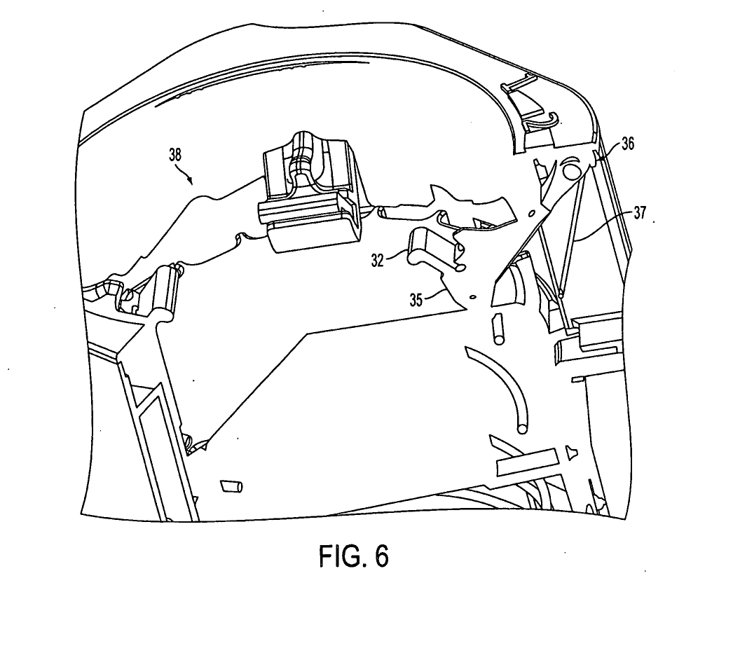

FIG. 6 illustrates an alternate head structure for use with the dispenser of FIG. 1.

FIG. 1 shows an exemplary dispenser 10 for cups or cup-shaped objects. The dispenser 10 may include a first tube section 11 and a second tube section 12. Each tube section may be cylindrical or of another shape, and the second tube section 12 furthest away from the dispensing head 30 may have a diameter smaller than the first tube section 11 that is closer to the head 30. In this manner, second tube section 12 may telescope into first tube section 11 to make an overall length of the dispenser 10 longer or shorter such that a single device may fit within a variety of differently sized cabinets or other housing structures. Conversely, the second tube section 12 may have a diameter larger that the first tube section 11 such that the first tube section may telescope into the second tube section. Either way, the outer tube section may be removably secured around the inner tube section at various positions using any appropriate means, such as grooves, clips, ribs, or the like.

The first and second tube sections, 11, 12, may be made of plastic, a polymer, a metal, an alloy or another material that is rigid enough to allow the tube to hold the cups in place while still maintaining its shape so as to not damage the cups inside the dispenser 10. Inside the dispenser 10 a piston 50 and spring 70 may occupy any empty space within the dispenser until cups are inserted. The spring 70 may abut the closed end 13 of the dispenser 10, and it may coil along the dispenser's axis to end at or within the piston 50. The piston 50 may be removeably attached to the spring 70 such that the piston may be removed for cleaning. Similarly, the spring 70 may be removeably attached to the closed end 13 of the dispenser such that the spring may be removed to clean the interior of the dispenser. The piston 50 may be constructed from a similar material as the dispenser 10, e.g., plastic, a polymer, a metal, an alloy or another similar material, although similarity of materials is not required. The spring 70 may be a compression coil spring made of a metal such as steel or a suitable alloy that provides any necessary pushing force for moving the cups through the dispenser 10 toward the open end 15.

FIG. 1 also shows a perspective view of a cup dispenser 10A having the same type of structure as dispenser 10. As before, the dispenser 10A may include a spring 70 abutting closed end 13 of the dispenser. The spring 70 pushes piston 50 toward the open end 15 of the dispenser 10A.

FIG. 2 illustrates an exemplary piston 50 and spring 70 that may be used in the dispenser of FIG. 1. FIG. 2A shows a side view of the piston 50 and spring 70 while FIG. 2B shows a cross-sectional view of the piston 50 and spring 70. As shown in FIG. 2A, piston 50 may contain ribs 51 that allow the piston to be retained within the dispenser by a small amount of friction, but not exhibit an overly tight fit that may prevent the spring 70 from pushing the piston through the dispenser. As discussed before, the piston 50 may be made of plastic or another rigid material, while the spring 70 may be made of stainless steel or another rigid material that may be coiled. FIG. 2C shows that piston 50 may include cross bars 52 or other structures that prevent cups from moving completely through the inside of the piston. As shown in FIG. 2B, the piston may include a space 53 where the spring 70 may be wound into the piston by varying amounts, thereby allowing a user of the dispense to adjust the tension of the spring, thus adjusting the force by which cups are dispensed.

FIG. 3 shows four views of an exemplary head assembly 30. Head assembly 30 may include a frame 31 that fits at least partially over the first tube structure as shown in FIG. 1. The head assembly 30 may also include a set of tabs 32 that extend within the opening 15 of the head assembly 30 to retain cups within the tube. The head assembly 30 also may include a dial ring 33 or other device that moves a cam within the head assembly to adjust the positions of the tabs to provide a larger or smaller diameter within the head assembly such that cups of varying diameters may be securely held by the head assembly. The ring 33 may include markings indicating how far the tabs are extended into the opening 15, and thus, providing an indication of what diameter cups the head assembly is set to accommodate. For example, FIG. 3 shows an embodiment of a head assembly 30A where the tabs 32 may be at a fully extended position in which the head assembly is configured to hold cups with a smaller diameter. Embodiment 30B shows the tabs 32 extended only to a mid point position in which the head assembly is configured to hold cups with a medium sized diameter. Embodiment 30C shows the tabs 32 withdrawn so that only a small portion of the tabs extend into the head assembly in which the head assembly is configured to hold cups with a larger diameter.

It should be noted that the three embodiments shown in FIG. 3 are given by way of example only. Additional configurations may be included for holding a larger range of cup diameters. For example, a locking device may be included for locking the ring 33 at any position, thereby providing for a completely customizable tab length determined by the diameter of the cup to be dispensed.

Each tab may be made of a rigid material such as plastic, with a flexible and/or durable tip, such as a silicone over structure, to hold cups in place. FIG. 3 shows embodiments with four tabs. However, any number of tabs may be used, such as three tabs or five tabs, so long as they are sufficient to hold the cups in place.

Referring back to FIG. 1, the cup dispenser may include retaining structures 14 such as ribs, raised edges or tabs, that meet with retaining structures on the head assembly 30 to hold the head assembly in place.

FIG. 4 illustrates an exemplary mounting system 40 that may be used to secure the dispenser 10 to a cabinet in which it is placed. As shown in FIG. 4A, the dispenser 10 may include a raised area such as a securing clip 14 or other structure and recess, such that when the dispenser is pushed into the cabinet, the cabinet will push within the recess. A gasket 18 may fill some or all of the space within the recess that the cabinet does not fill to eliminate any debris from going into the interior of the cabinet during normal use.

As shown in FIG. 4B, the raised securing members 14 also may interlock with structure on the head assembly 30 so that the head assembly is secured to the dispenser 10 outside of the cabinet. This arrangement may provide easy access to the ring 33, thus allowing the position of the clips 32 to be quickly changed without removing the dispenser 10.

It should be noted that the dispenser 10 being mounted in a cabinet is shown by way of example only. The dispenser 10 may be mounted in various areas and positions depending on the surrounding environment. For example, the dispenser 10 may be mounted directly to a beverage dispensing machine.

FIG. 5 is a cross-sectional view showing the head assembly 30 and first tube section 11 showing the tabs 32, e.g. silicone tabs 32 as shown in FIG. 5, being attached to a cup retainer flipper 35. The flipper 35 may be secured to the head assembly 30 by an axle 36 that allows the flipper to pivot. A spring 37 may provide tension to hold the flipper against the cups that are placed inside the tube. As mentioned above, head assembly 30 may include a ring that rotates about a cam assembly. As the ring 33 rotates, the cam assembly increases or decreases the tension in the spring 37, thus increasing or decreasing the tension applied by the spring on the flipper 35. This varying tension may determine the overall length of the tab 32, thus determining the diameter size of a cup to be held in the dispenser.

As shown in FIG. 6, an adjustment ring 38 may be included inside the head assembly 30 such that when the head assembly is turned, the adjustment ring 38 causes the flippers 35 to rotate about the pivot 36 thus raising or lowering them. This results in an extended or retracted tab 32, and thus provides a smaller or larger diameter within the dispenser, respectively.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art are also intended to be encompassed by the following claims.

1. An assembly for holding cup-shaped objects comprising:
an outer retaining tube;
an inner retaining tube having a diameter smaller than that of the outer retaining tube, wherein the inner retaining tube engages the outer retaining tube in a telescoping manner;
a spring positioned inside the tubes; and
a piston positioned at a first end of the spring.

2. The assembly of claim 1, further comprising a head assembly that engages the outer retaining tube, the head assembly containing a ring assembly that when rotated varies the length of a plurality of cup retaining tabs.

3. The assembly of claim 1, further comprising a head assembly that engages the outer retaining tube, the head assembly containing a ring assembly that when rotated provides a varying diameter within the head assembly.

4. The assembly of claim 1, wherein the piston is configured such that a varying amount of the spring may be coiled in the piston thereby adjusting the length and resulting tension of the spring.

5. An assembly for holding cup-shaped objects comprising:
an outer retaining tube;
an inner retaining tube having a diameter smaller than that of the outer retaining tube, wherein the inner retaining tube engages the outer retaining tube in a telescoping manner;
a spring positioned inside the tubes;
a piston positioned at a first end of the spring; and
a head assembly that engages the outer retaining tube, the head assembly containing a ring assembly that when rotated provides a varying diameter within the head assembly.

6. The assembly of claim 5, wherein the piston is configured such that a varying amount of the spring may be coiled in the piston thereby adjusting the length and resulting tension of the spring.

7. The assembly of claim 5, wherein the head assembly comprises a plurality of cup retaining tabs whose length may be varied by rotation of the head assembly.

8. The assembly of claim 7, wherein the head assembly further comprises a cam assembly operably connected to the plurality of cup retaining tabs and configured to adjust the length of the plurality of cup retaining tabs in response to rotation of the ring assembly.

9. The assembly of claim 8, wherein the cam assembly is operably connected to the plurality of cup retaining tabs via a plurality of adjustable flippers.

10. The assembly of claim 9, wherein the cam assembly adjusts the length of the plurality of cup retaining tabs by increasing or decreasing tension on the plurality of adjustable flippers.

11. An assembly for holding cup-shaped objects comprising:
an outer retaining tube;
an inner retaining tube having a diameter smaller than that of the outer retaining tube, wherein the inner retaining tube engages the outer retaining tube in a telescoping manner;
a spring positioned inside the tubes;
a piston positioned at a first end of the spring; and
a head assembly that engages the outer retaining tube, the head assembly containing a ring assembly operably connected to a plurality of flippers that, in response to rotation of the ring assembly, provide a varying diameter within the head assembly.

12. The assembly of claim 11, wherein the piston is configured such that a varying amount of the spring may be coiled in the piston thereby adjusting the length and resulting tension of the spring.

13. The assembly of claim 11, wherein each of the plurality of flippers is connected to one of a plurality of cup retaining tabs.

14. The assembly of claim 13, wherein the head assembly further comprises a cam assembly operably connected to the plurality of flippers and configured to adjust a level of tension applied to each of the flippers response to rotation of the ring assembly, thereby adjusting the length of the plurality of cup retaining tabs.

15. The assembly of claim 11, further comprising a mounting system for mounting the assembly to a cabinet.

16. The assembly of claim 15, wherein the mounting system comprises at least one securing clip configured to secure the assembly to the cabinet.

17. The assembly of claim 1, wherein:
the inner tube and the outer tube form a telescoping dispenser having an adjustable length; and
the spring is configured to exert a variable pressure on the cup-shaped objects by adjusting a length and resulting tension of the spring based upon the adjustable length of the telescoping dispenser.

18. The assembly of claim 5, wherein:
the inner tube and the outer tube form a telescoping dispenser having an adjustable length; and
the spring is configured to exert a variable pressure on the cup-shaped objects by adjusting a length and resulting tension of the spring based upon the adjustable length of the telescoping dispenser.

19. The assembly of claim 11, wherein:
the inner tube and the outer tube form a telescoping dispenser having an adjustable length; and
the spring is configured to exert a variable pressure on the cup-shaped objects by adjusting a length and resulting tension of the spring based upon the adjustable length of the telescoping dispenser.
